(19) United States
(12) Patent Application Publication
(10) Pub. No.: US 2007/0041423 A1
(43) Pub. Date: Feb. 22, 2007

(54) A package for storing goods in a preservative state provided with a temperature indicator and method for making such packages

(75) Inventors: Mats Nygårdh, Järvsö (SE); Henry Norrby, Jarvso (SE)

Correspondence Address: DILWORTH & BARRESE, LLP, 333 EARLE OVINGTON BLVD., UNIONDALE, NY, 11553, US

(73) Assignee: TEMPIX AB, Jarvso (SE)

(21) Appl. No.: 10/572,076

(22) PCT Filed: Sep. 14, 2004
(86) PCT No.: PCT/SE04/01317

§ 371 Date: Mar. 16, 2006

(30) Foreign Application Priority Data
Sep. 16, 2003 (SE) 0302455-1

(51) Int. Cl. G01K 13/00

(52) U.S. Cl. 374/141

(57) ABSTRACT

A package (1) is provided for storing goods in a preservative state where the temperature must be maintained below a set value and having a bar-code (2) which is applied in a surface field (4) omitting extraneous prints and a temperature indicator (3) having variable optical properties when the temperature passes the set limit. The temperature indicator (3) at least partially overlaps the surface field (4) with one or more of the bars in the bar-code (2) being applied on top of the temperature indicator (3). A method for making the package (1) is also provided.

### TECHNICAL FIELD OF THE INVENTION

In a first aspect, this invention relates to a package for storing goods in a preservative state in which the temperature must not pass a set limit value, the package comprising, on one hand, a bar-code, which in the usage state of the package is applied in a surface field reserved for the same, in which field extraneous prints must not be present, and on the other hand a temperature indicator, the optical properties of which are variable, when the temperature passes said limit value.

In a second aspect, the invention also relates to a method for making such packages.

### DESCRIPTION OF THE PRIOR ART

Chilled and deep-frozen foods, respectively, are handled in large amounts within the food sector. During the period between production, when the goods are chilled or deep-frozen, and retail sale to final consumer, it is of vital importance that the temperature of the package and the goods contained in the same do not exceed a certain recommended limit value, which for deep-frozen products usually is −18° C. and for chilled products +4° C. (at times +8° C.). If the goods during a certain time would unintentionally obtain a higher temperature than the recommended limit value, it is risked that the quality of the goods is deteriorated, and if the exposure to the forbidden high temperature would become long, the goods may become completely unhealthy by growth of bacteria. The handling of the goods from producer to consumer includes in practice a plurality of different phases, such as storage, transshipments, transports as well as handling in the shop. There are, per se, strict rules and recommendations how the temperature of the goods should be monitored and documented during these different phases, but in practice, the rules are difficult to observe completely. If the individual goods on some occasion by misadventure or in another way would be exposed to higher temperature than the recommended highest limit value, neither the consumers nor other parties in the chain between producer and consumer have previously been able to see this on the proper package.

With the purpose of managing the above-mentioned problems, it has by WO 01/72601 (SE 0001069-4) been proposed a package having a temperature indicator, which is especially intended for monitoring the freshness of deep-frozen foods. This temperature indicator makes use of a contrast fluid, which is initially transparent and preserves the transparency thereof during a temperature reduction past a certain limit value, but is converted in an irreversible way to an opaque, coloured state, if the temperature would exceed the same value. In a particular embodiment, the temperature indicator is utilized in order to cover a bar-code by an initially transparent part. The intention hereby is that the temperature indicator in the transparent state thereof should enable scanning of the code, but in a triggered, coloured state make conventional scanning of the bar-code impossible. During the development of the temperature indicator being the subject of WO 01/72601, it has, however, turned out that the normal scanning of the bar-code, i.e., scanning of fully fresh goods on the packages of which the temperature indicator has not been triggered, is made more difficult in spite of the contrast fluid included in the temperature indicator still being transparent.

### OBJECTS AND FEATURES OF THE INVENTION

The present invention aims at obviating the code scanning problems that are associated with the package according to WO 01/72601 and at providing an improved package. Thus, a primary object of the invention in a first aspect is to provide a package for goods having a bar-code as well as a temperature indicator, which can separate fresh goods from unfresh without aggravating normal scanning of a bar-code by means of conventional, existing scanning equipment. An additional object is to provide a package in which the requirements on precision in application of, on one hand, a bar-code and on the other hand a separately made temperature indicator interacting with the same, are moderate. In other words, the nature of the package should enable quick and easy application of the respective components in connection with the daily, current marking of packages for goods, whether this is carried out at the producer/wholesaler or in the shop. Another object of the invention is to provide a package that can be used for frozen as well as chilled goods.

According to the invention, at least the primary object is attained by the features defined in the characterizing clause of claim 1. Preferred embodiments of the package according to the invention are furthermore defined in the dependent claims 2-13.

In a second aspect, the invention also relates to a method for making packages of the kind in question. The features of this method are seen in the independent claim 14.

### SUMMARY OF THE INVENTION

The invention is based on the intention to apply a temperature indicator on the package in a first step, which indicator partially overlaps a surface field reserved for a bar-code in which field extraneous prints must not be present, and to apply the bar-code in a second step, more precisely in such a way that one or more of the bars in the bar-code cover the temperature indicator, i.e., are present on top of the same. In such a way, the temperature indicator, which advantageously is in the form of a separate label, can be fastened on the package without other demand on precision than that the same should partially overlap the surface field reserved for the bar-code, whereupon the bar-code is applied without other demand on precision than that at least one of the bars in the same should be located on top of the temperature indicator. In such a way, on one hand it is guaranteed that the normal scanning of the bar-code will be reliable during all conditions, and on the other hand that a colour alteration of the temperature indicator triggered by a temperature limit passage affects the bar-code in such a way that said passage is observed in the shop's computer system connected to the code scanner.

### FURTHER ELUCIDATION OF PRIOR ART

By DE 19912529, a temperature indicator is previously known in the form of a label applicable to packages for goods, which label, in addition to a thermally reactable layer having a variable colour, includes a transparent top coat in which a bar-code is integrated. As long as the goods in question holds the desired temperature, the reactable layer remains unaffected and the bar-code scannable, but if the desired temperature is exceeded, the lower layer changes colour and makes the bar-code unscannable. However, a disadvantage of this label is that the same is intended to form the individual price or weight code of the goods package, which means that an extremely large number of different labels have to be manufactured, distributed, stored and applied to the thousands of different goods, which are in circulation in the convenience goods trade and which require individual code marking.

### BRIEF DESCRIPTION OF THE APPENDED DRAWINGS

In the drawings:

FIG. 1 is a perspective view of a package for goods made with a bar-code and a temperature indicator,

FIG. 2 is a perspective view that schematically illustrates a surface field on the package, which field is reserved for printing the bar-code, as well as a partially cut view of the temperature indicator, shown from the bottom side,

FIG. 3 is a perspective view showing a first production step in which solely the temperature indicator has been applied in connection with the reserved surface field,

FIG. 4 is a perspective view corresponding to FIG. 3, showing a second production step during which also the bar-code is applied to the package,

FIG. 5 is a perspective view illustrating how the temperature indicator is primed for temperature surveillance,

FIG. 6 is a perspective view of the same indicator after triggering, and

FIGS. 7-10 are perspective views corresponding to FIGS. 3-6 and showing an alternative embodiment of a temperature indicator during application, priming and triggering, respectively.

### GENERAL SUMMARY OF BAR-CODES OF THE TYPE EAN

Before the invention is described more in detail, it should be pointed out that bar-codes of the type that are applied to packages for foods and other commodities usually consist of so-called EAN codes, where the letters EAN stand for European Article Number. This constitutes a worldwide system for article numbering of all types of consumer goods. The system is administered by “International Article Numbering Association, EAN”, which issues instructions to the users having joined the system. EAN is used in shops having computerized paydesks and a fixed or mobile bar-code scanner. Upon the symbol scanning, a registration of the EAN code takes place in the computer system of the shop. The most common bar-codes consist of price codes and weight codes, respectively. When registration takes place, a number of measures are triggered if a code is in the price memory of the computer system. The price and the merchandise description, which the shop has entered into the computer system, are shown to the customer through a price window. The specifications are printed in plain text on the receipt of the customer and the computer sums up the amount that shall be paid. At possible price changes, the goods do not need to be remarked. Furthermore, by using special programs in the computer system, there is a possibility to assemble information in an expedient way, which may be combined in order to form a basis for order quantities, composition of class of goods, pricing, etc. The code scanners on the market make use of infrared light, which illuminates the bars as well as the intermediate neutral fields in a bar-code, the contrast between the bars and said fields being crucial to the quality of scanning. Generally, the black or dark bars in a bar-code absorb the light, while the white or light fields between the bars reflect the light. In larger scanners, the bars are illuminated by a grid of light beams. If the bars are of a dark colour, such as black or blue, at the same time as the neutral fields are light, e.g., white or yellow, an optimum contrasting effect is obtained. However, also other combinations of colour may exist. The essential thing is that the infrared light is either absorbed or reflected by the colouring substances in question. Of course, the distinctness of the code bars is also of great importance.

### DETAILED DESCRIPTION OF PREFERRED EMBODIMENTS OF THE INVENTION

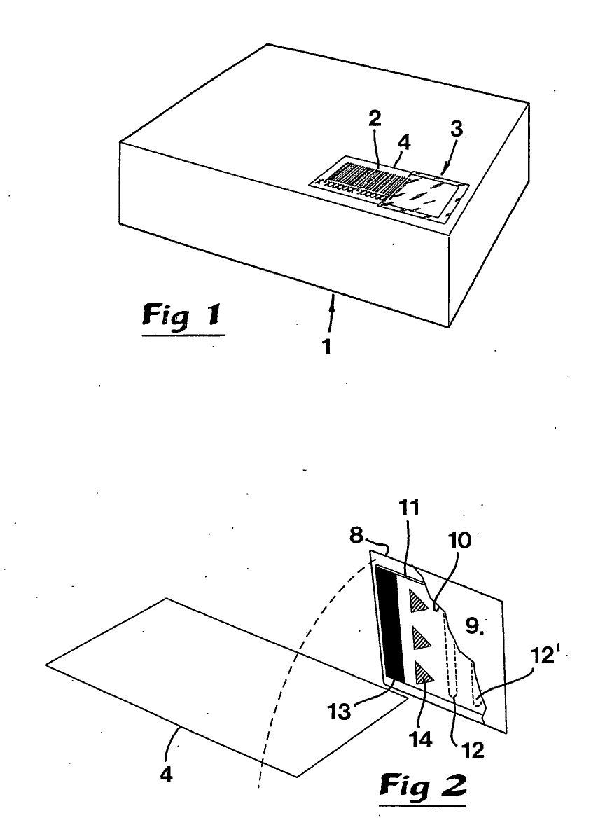

In FIG. 1, 1 generally designates a package for goods, e.g., in the form of a package for frozen or chilled goods, which in the example has a parallelepipedic, flat basic shape. In practice, the package may consist of a capsule of comparatively stiff board or cardboard. On one of the part surfaces of the package, a bar-code 2, as well as a temperature indicator in its entirety designated 3 are applied. The bar-code 2 may consist of a conventional price code and/or weight code (commodity code). For the bar-code, a surface field 4 is reserved in which extraneous prints must not be present. In practice, said surface field may either be real so far that the same is delimited by a visible frame or line, such as in FIGS. 1 and 2, or be imaginary so far that the surface in question on the package without surrounding frame simply lacks any form of print, which could disturb the code scanning. By scanning in an available code scanner, the bar-code 2 enables usual data capture in a shop's computer system.

As is seen in FIGS. 1 and 4, the bar-code 2 includes a plurality of code bars 6 located between outer bars 5 and having mutually varying thickness and location. Together said code bars form an elongate, rectangular configuration. Under the code bars, there is usually also a numerical series of Arabic figures, which in the example are designated “X”. In the area outside the two outer code bars, neutral fields 7, without text and pictures are left in order to enable scanning in accordance with current bar-code technique. In practice, said fields 7 should have a width of at least 2.7 mm in order to guarantee an undisturbed code scanning. The individual code bars may have black, blue or another dark colour, while the neutral fields positioned between and outside the code bars may have a white, yellow or another light colour. The essential thing in this connection is that contrasting effect is attained by the infrared light of a code scanner either being absorbed or reflected by the different colours. It should also be pointed out that each outer code bar 5 together with a nearby code bar 5′ is, in the usual way, somewhat longer than the majority of the other, intermediate code bars 6.

Characteristic of the package according to the invention is that the temperature indicator 3 at least partially overlaps the surface field 4 reserved for the bar-code, and that one or more of the bars in the bar-code are applied on top of the temperature indicator. Although the temperature indicator 3 may be realized in many different ways, in the example, the same has the form of a label having an exposed, visible top side or outside 8 in the applied state and a hidden bottom side 9, which advantageously may include a finishing (not shown) by means of which the label may be pasted on the package. In practice, the label may be manufactured from a thin, transparent plastic foil or film, which in its entirety forms a casing designated 10. For instance, the production may take place by the fact that the foil is folded along an end edge and welded together along two long-side edges and an opposite end edge. The casing defines a hollow space in which a porous, capillary suctioning means 11 is housed, which advantageously may be composed of a strip of paper or other fibrous material. In practice, the two foil parts that surround the strip 11 should lie in close contact with the outside as well as the inside of the same.

Furthermore, inside the casing 10 at least one burstable capsule 12 is arranged, which contains liquid. In the shown, preferred embodiment, two such capsules, 12, 12′, are present, which are placed fairly near each other in the area of one end edge of the label. Each individual capsule is manufactured from a thin film of a material, e.g., a suitable plastic, that retains a fundamental elasticity or softness at a certain temperature, e.g., near 0° C., but becomes brittle at lower temperatures, e.g., below −16° C. The liquid contained in the individual capsule may for instance consist of a mixture of alcohol and water in such proportions that the freezing point of the liquid mix is at, for instance, −16° C. Such a liquid mix is colourless and transparent.

Paper and similar fibrous materials have different optical properties in dry and wet state, respectively. More precisely, in a dry state the top side of a white or brightly coloured paper is opaque so far that only the surface, but not the interior of the paper fibre web, can be seen by the eye. However, as soon as the fibre web is wetted, the same becomes transparent in so far that at least the outermost layer in the fibre web can be seen through. This phenomenon may in the invention be utilized in such a way that the strip 11 is provided with one or more prints that are invisible from the top side as long as the strip is dry, but which are made visible when the strip is wetted. Although the number of prints as well as the physical shape and location thereof in the fibre web may be varied in a multiple of ways within the scope of the invention, two different prints 13, 14 are shown in the example according to FIGS. 2-6, which prints are applied on the back or bottom side of the strip 11. In this connection, it should be reminded that the top side 8 of the strip is covered by the transparent plastic foil and is therefore always visible to the eye, while the back side of the strip is facing the package 1 and therefore not exposed in the direction of the observer. The print 13, which is located in the immediate vicinity of one end edge of the strip, consists of a border that extends along the larger part of the width of the label, while the print 14 consists of a number of warning triangles. The different prints may advantageously have different colours that, however, always should deviate from the colour of the strip 11. The same may advantageously be white or at least light in order to reflect infrared light of the type that is used in code scanners. The colours in the prints 13, 14 should be generally darker than the white or light colour in the strip. Advantageously, the colour in the print 13 may be black, while the triangular prints 14 may be of, for instance, yellow, red or orange colour.

### THE MANUFACTURE AND FUNCTION OF THE PACKAGE ACCORDING TO THE INVENTION

Although series manufacturing of the label serving as temperature indicator as such can be carried out in various ways, the print-carrying strip 11 should be pre-printed on one side thereof, after which it is contained in the casing. Before sealing the same, also the liquid capsules 12, 12′ are inserted either by being inserted in the strip 11 (e.g., in countersinks in the same) in advance or by being placed between the strip and the surrounding casing.

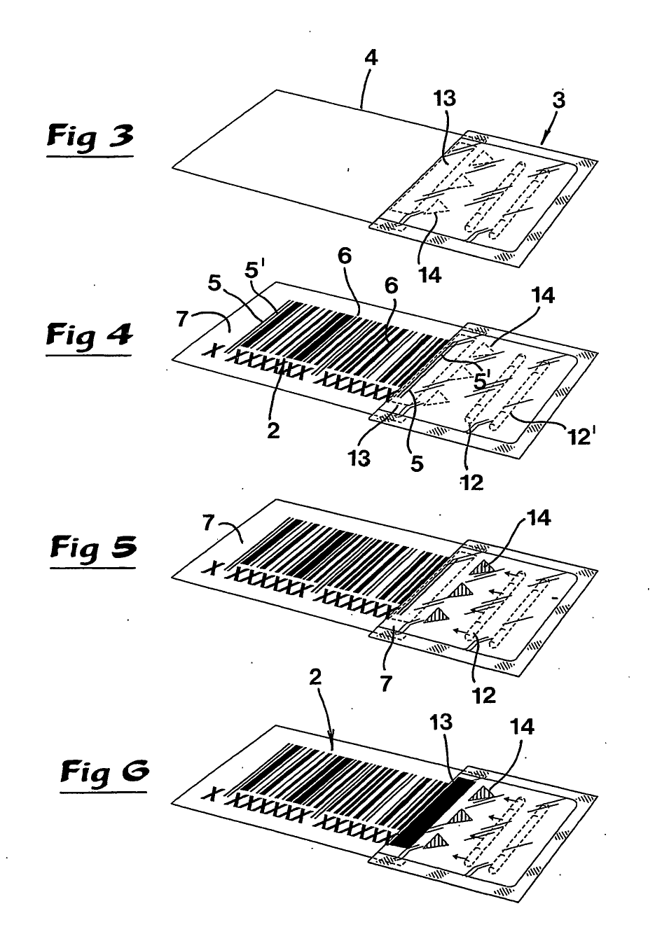

In order to complete the package according to FIG. 1, also a bar-code 2 is required in addition to the temperature indicator. It is feasible, per se, to provide said bar-code by means of a transparent label on which the bar-code has been printed. However, in practice it is preferred to print the bar-code directly, e.g., by means of a print pad, an ink jet printer or the like. Generally characteristic of the invention is that the application of the bar-code is not carried out until after the temperature indicator having been applied. This is illustrated in FIGS. 3 and 4, in which it is seen how the temperature indicator 3 in a first step is applied, e.g., is pasted, on to the package in such a way that the same partially overlaps the surface field 4, which is reserved for the bar-code 2. In doing so, the location of the temperature indicator in relation to the surface field 4 does not need to be meticulously accurate. Thus, it is only essential that the end edge of the indicator projects inward and covers some millimetres of the surface field. However, in practice, the label should be placed with the end edge thereof at a distance of 3-15 mm from the end edge of the surface field 4. In this connection, it should be pointed out that there are no requirements on parallelism between said end edges. When the temperature indicator has been fixed in the position shown in FIG. 3, the bar-code 2 is applied in a subsequent step, more precisely in such a way that one or more of the bars in the bar-code, e.g., the bars 5, 5′, are applied on top of the temperature indicator, as is shown in FIG. 4. In this case as well, there are no requirements on parallelism between the code bars and the temperature indicator. It is only essential that at least the outermost code bar 5 entirely covers or partly overlaps the border-like print 13 of the temperature indicator.

Arbitrarily long time after the manufacture, the disclosed temperature indicator/the label can be primed for use, more precisely in connection with the fact that a storing period of a packaged quick-frozen food item should be initiated. The only essential in this respect is that the label before priming is not exposed to temperatures below the limit value that should be monitored (e.g., −16° C.). Conventionally, freezing of quick-frozen food is carried out at very low temperatures in order to hasten the freezing process. Inside the temperature indicator, the following then takes place: As the temperature falls from room temperature, heat is transported from the liquid capsules 12, 12′ via the casing to the cooled surroundings. When the temperature has dropped to, for instance −16° C., the liquid in the capsules freezes to ice and begins to expand. Simultaneously, the material in the capsule walls has become brittle, said expansion resulting in that the capsules bursts (in practice, cracks are formed in the capsule walls). The bursting means that an irreversible way of communication arises between the interior of the capsules and the surrounding paper fibre web. However, as long as the temperature is below said limit value, no exit of liquid from the capsules takes place because the liquid still exists in solid form, more precisely as ice. The temperature indicator is now primed.

However, if the package 1 together with the temperature indicator 3 thereof at some occasion during the handling from producer to consumer would unintentionally come to be thawed by being exposed to temperatures above the limit value during a considerable time, the ice will melt and return to liquid state. Then, the accordingly triggered liquid is first sucked into the fibre web in the immediate vicinity of the capsules 12, 12′ (see FIG. 5) and reaches the print 14, whereupon continued capillary suction causes the strip in its entirety to become wetted, as is shown in FIG. 6. In this connection, the strip becomes transparent so that the two prints 14, 13 appear from the outside of the label. More precisely, the dark (red, yellow, orange) print 14 appears in a first stage, and then the likewise dark (e.g., black) print 13. In this connection, the print 14 brings about a marking or warning visible to the naked eye that an exceeding of temperature is imminent, whereupon the print 13 certifies that this has taken place, all while making normal scanning of the bar-code impossible. Via the code scanner, hence the computer system can register that the temperature limit value of the quick-frozen food item in question has been exceeded.

### ALTERNATIVE EMBODIMENTS

In an alternative embodiment of the package particularly suited for chilled products, a temperature indicator is used the wetting agent of which consists of a liquid, which has a semi-plastic consistency at temperatures below a certain limit value, but becomes liquid at temperatures above the same. For chilled products in general and chilled foods in particular, the chosen limit value should be in the temperature range of 0 to +12° C., suitably between +2° C. and +10° C. For specific foods, the limit value may be set to either +4° C. or +8° C.

Because the liquid in question should have the capability to transform or be converted from one viscosity state to another, more precisely between, on one hand, a state of low viscosity, and on the other hand a semi-plastic state or possibly a state of high viscosity—depending on the ambient temperature—said liquid will henceforth be denominated conversion liquid.

The choice of conversion liquid is determined by a plurality of factors, one of which consists of the character of the packaged goods. Thus, if the goods consists of a food item, a liquid that is not toxic and/or chemically active should be chosen. Therefore, for the purpose, vegetable or animal oils of the type that has a melting point (pourpoint) or viscosity transition temperature within the range of 0-12° C. are suitable. Experiments having preceded the invention have shown that olive oil is particularly expedient. Therefore, below a brief account of a practical experiment follows.

An olive oil of the make “BERTOLLI GENTILE, Extra Vergine” was cooled down in a refrigerator to a temperature of +3° C., whereupon the sample was taken out in room temperature for the measurement of the temperature change as well as the consistency of the oil once per minute during totally 6 min. Below, the result of the same measurement follows in tabular form.

| Time | Temperature | |
|---|---|---|
| (minutes) | (° C.) | Consistency |
| 0 | +3.4 | Semi-plastic, honey-like |
| 1 | +4.5 | Semi-plastic, honey-like |
| 2 | +6.0 | Indication of liquefaction |
| 3 | +7.5 | Liquefaction initiated |
| 4 | +8.6 | Of high viscosity |
| 5 | +9.8 | Of low viscosity |
| 6 | +10.3 | Of low viscosity |

Thus, during the relatively narrow temperature range of 2.6° C. between +6.0° C. and +8.6° C., the olive oil in question transforms from a non-liquid, semi-plastic state to a state of low viscosity.

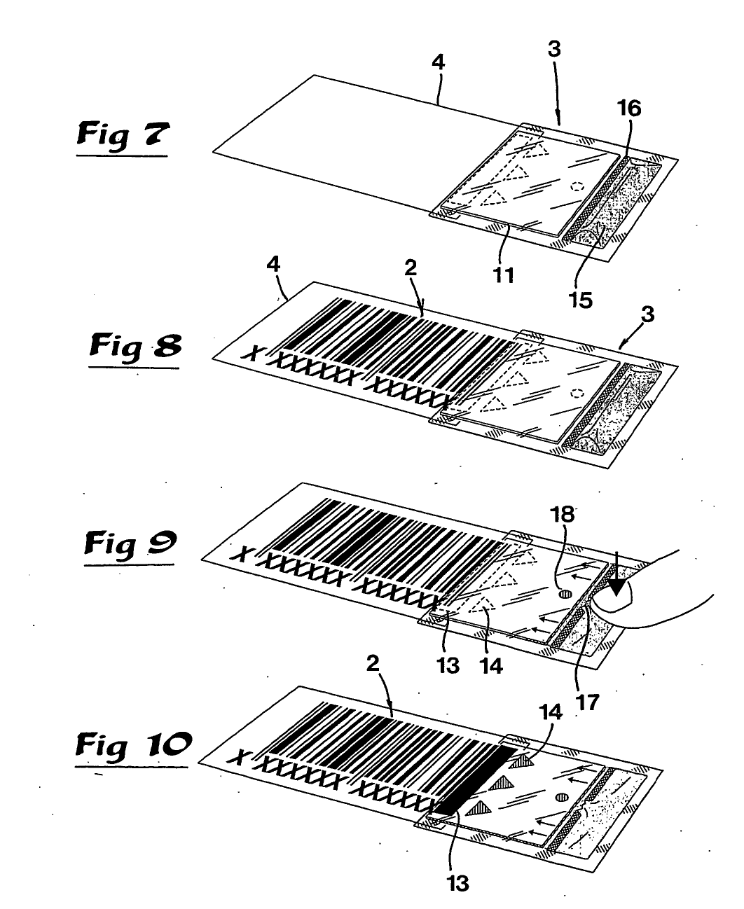

A temperature-indicating label, particularly suitable for chilled products, is shown in FIGS. 7-10. In this case, a conversion liquid of the above described type is contained in a capsule 15, which is connected to the label via a welded material portion 16 in which one or more weakened portions 17 are included, which may form an open way of communication between the capsule and the inside of the casing. Furthermore, a constriction (not shown) may be included in the label, where the material in the paper strip is compressed. In such a way, advance of the liquid in the strip is delayed or counteracted. In this case, priming takes place by a mechanical pressure being applied against the capsule 15. Said pressure may be provided either in a manual way, e.g., by means of fingers, or in a mechanical way by means of the tool that is used to apply the label on the package. When the liquid pressure in the capsule 15 is raised sufficiently high, the weakened material portion 17 in the welding 16 serving as a valve breaks, whereby the liquid is free to penetrate in the direction of the strip. By initially executing the priming in an environment where the ambient temperature is below the limit value that is determined by the melting point of the liquid (e.g., +4° C.), it is, however, guaranteed that the liquid not immediately is sucked into the strip in its entirety. Thus, the still semi-plastic liquid will only penetrate a short distance into one end portion of the strip. This may be indicated via a third print 18. In practice, the capsule 15 is punctured at the earliest in connection with the indicator being applied to the package 1 and/or the goods being introduced into a refrigerating space, for instance at a manufacturer/distributor or in a shop. In this state, the strip 11 is unaffected by the liquid with the exception of the end portion positioned closest to the capsule 15. In other words, the prints 13, 14 are still hidden under the outwardly turned surface layer of the paper fibre web.

Suppose that the temperature limit value in question of the goods is set to +4° C. As long as the ambient temperature is below the same value, the label remains in the initial state thereof. However, if the temperature during storing of the goods would exceed +4° C., the consistency of the liquid will be transformed from semi-plastic to be of low viscosity. By the capillary effects in the porous strip 11, the liquid will then be sucked into the strip and completely wet the same, whereupon the two prints 13 and 14 will appear and become visible from the outside of the label. In such a way, the observer as well as the computer system (upon code scanning) are made aware that the temperature limit value has been exceeded.

Conventional code scanning can be carried out without hindrance as long as the strip 11 is dry and white/light, but as soon as the strip is wetted, the dark border 13 appears and makes scanning of the code impossible because the border absorbs the infrared light of the code scanner.

A delay of the advance of the liquid of low viscosity in the fibre web may also be accomplished by making the fibre web with spaced-apart sections, which have different porosity or capillary effects. By in a suitable way delaying the liquid penetration, it is guaranteed that the goods has to be exposed to a harmfully increased temperature during a certain time in order to trigger the indicator. Hence, a short exceeding of the temperature limit value, e.g., the time during which the customer stays in a shop (usually max. approx. 30 min), will not lead to the indicator being triggered. In this connection, it should also be pointed out that a viscous conversion liquid of the type oil in itself has the property that a triggering of the temperature indicator registrable by the code scanner does not come into effect as a consequence of a short temperature rise only. Namely, if a temperature rise arises and the package a short time thereafter is cooled down, it is true that the liquid initially will commence to flow in the strip, but thereafter again become viscous or stiff. This means that the diffusion of the liquid in the direction of the print 13 co-operating with the bar-code is checked and entirely stops before the liquid reaches up to the same.

It is obvious that a semi-plastic conversion liquid of the type that has been described above in connection with FIGS. 7-10 also can be used in capsules of the type that are integrated in the fibre web in the way shown in FIGS. 3-6. It is even feasible to have, in a combination, a semi-plastic conversion liquid in one capsule and a freezing liquid (e.g., water/alcohol) in another.

As has initially been mentioned, the technical embodiment of the temperature indicator is of minor importance for the realization of the invention. The temperature indicators illustrated in FIGS. 3-6 and 7-10, respectively, for quick-frozen foods and chilled products, respectively, should therefore be seen as non-limiting examples of indicators. In other words, it is possible to make the temperature indicators in another way, e.g., by integrating micro capsules of the type that is disclosed in U.S. Pat. No. 4,729,471 in a fibre web or other capillary suctioning means. Such micro capsules, which are extremely small and may be introduced in large quantities in a fibre web, include a liquid contained in a burstable outer shell, which below a certain temperature limit value is solid or semi-plastic, and which above this value becomes of low viscosity. A temperature indicator containing such micro capsules may be primed by applying a mechanical pressure to the fibre web/the paper strip, which pressure means that the shells burst. If this occurs below the temperature limit value, the liquid is made ready to flow out into and dye the paper web when the limit value is exceeded.

### FEASIBLE MODIFICATIONS OF THE INVENTION

The invention is not solely limited to the embodiments described above and illustrated in the drawings. Thus, the temperature indicator and the interaction thereof with the package may be varied in multiple ways. For instance, it is feasible to apply the dark or light-absorbing print on the package instead of the underneath side of the label that forms the temperature indicator. In other words, the print or signal element that is to appear upon triggering does not necessarily need to be integrated with the proper temperature indicator. It is also possible to make the temperature indicator in accordance with prior art, e.g., such as this is represented by DE 19831519 A1, U.S. Pat. No. 4,148,748, FR 2611899 (in addition to the above-mentioned U.S. Pat. No. 4,729,671). Furthermore, it is feasible to use the package according to the invention for goods, the ambient temperature of which must not pass below a certain limit value. In such cases, the temperature indicator of the package is primed at a temperature above the set limit value, e.g., above 0° C., in order to at a temperature reduction to and past the limit value trigger a colour-wise or another optic alteration that affects the scanning of the bar-code. Such packages, e.g., in the form of pots, cases, boxes, etc., may advantageously be used for storing of goods which must not freeze, e.g., paint, certain medicines, beverages, fruit and vegetables, etc. In this connection, it should also be mentioned that the package may include more than one temperature indicator. For instance, the package may be provided with one temperature indicator, which is capable of indicating whether a certain temperature value has been exceeded, as well as another temperature indicator, which marks whether the temperature has fallen below a certain, other value. Two such temperature indicators may then be applied at opposite ends of the bar-code in the way that characterizes the invention according to the subsequent claims.

1. Package for storing goods in a preservative state in which the temperature must not pass a set limit value, comprising a bar-code (2), which in the usage state of the package (1) is applied in a surface field (4) reserved for the same, in which field extraneous prints must not be present, and a temperature indicator (3), the optical properties of which are variable, when the temperature passes said limit value, wherein the temperature indicator (3) at least partially overlaps said surface field (4) and one or more of the bars (5, 5′) in the bar-code (2) are applied on top of the temperature indicator.

2. Package according to claim 1, wherein at least the part of the temperature indicator that is situated under one or more code bars (5, 5′) initially has a colour that reflects infrared light, and t a possible passage of the temperature limit value alters the externally observable colour of the indicator to a light-absorbing one.

3. Package according to claim 1, wherein at least one liquid is included in the temperature indicator (3), which liquid has the purpose of triggering a visualization of the ambient temperature having passed the limit value, and the same includes a porous, capillary suctioning means (11), which has a certain optic property in a dry state and another in a state wetted by said liquid.

4. Package according to claim 3, wherein the capillary suctioning means in the temperature indicator (3) is composed of a strip (11) of a porous material.

5. Package according to claim 3, wherein the capillary suctioning means (11) of the temperature indicator is housed in a space, which is defined by an at least partially transparent casing (10).

6. Package according to claim 3, wherein the liquid in the temperature indicator has a semi-plastic consistency at temperatures below said limit value, but becomes liquid at temperatures above the same.

7. Package according to claim 6, wherein the liquid in the temperature indicator (3) is composed of a vegetable and/or animal oil with or without viscosity-regulating means.

8. Package according to claim 3, wherein the liquid in the temperature indicator is included in a burstable capsule and has a melting point below 0° C.

9. Package according to claim 6, wherein the temperature indicator comprises two different capsules (12, 12′), one of which (12) contains a liquid that has semi-plastic consistency at temperatures below the limit value, but becomes liquid at temperatures above the same, while the second one (12′) contains a liquid, the melting point of which is below 0° C.

10. Package according to claim 1, wherein the temperature indicator (3) is in the form of a label having an exposed top side (8) and a bottom side (9), which is applied against the package.

11. Package according to claim 4, wherein at least one print (13, 14) is included in the strip (11), which print is invisible from the top side of the strip as long as the strip is dry, but which is made visible when the strip becomes transparent by wetting.

12. Package according to claim 4, wherein at least a certain part of the strip (11) in the temperature indicator (3) in a dry state has a light or light-reflecting colour, but gets a partially dark or light-absorbing colour when the strip is wetted.

13. Package according to claim 4, wherein along the strip of the temperature indicator, a plurality of different prints (13, 14, 18) are arranged having different information messages and/or specifications.

14. Method for making packages (1) of the type intended for storing goods in a preservative state, in which the temperature must not pass a set limit value and which comprises a bar-code (2), which in the usage state of the package is located in a surface field (4) reserved for the same, in which field extraneous prints must not be present, and a temperature indicator (3), the optical properties of which are variable, when the temperature passes said limit value, wherein the temperature indicator (3) is brought to at least partially overlap said surface field (4), and one or more of the bars (5, 5′) in the bar-code (2) are applied on top of the temperature indicator (3) at the earliest when the same has been applied on the package (1).

15. Package according to claim 2, wherein at least one liquid is included in the temperature indicator (3), which liquid has the purpose of triggering a visualization of the ambient temperature having passed the limit value, and the same includes a porous, capillary suctioning means (11), which has a certain optic property in a dry state and another in a state wetted by said liquid.

16. Package according to claim 15, wherein the capillary suctioning means in the temperature indicator (3) is composed of a strip (11) of a porous material.

17. Package according to claim 16, wherein the capillary suctioning means (11) of the temperature indicator is housed in a space, which is defined by an at least partially transparent casing (10).

18. Package according to claim 4, wherein the capillary suctioning means (11) of the temperature indicator is housed in a space, which is defined by an at least partially transparent casing (10).

19. Package according to claim 15, wherein the capillary suctioning means (11) of the temperature indicator is housed in a space, which is defined by an at least partially transparent casing (10).

20. Package according to claim 4, wherein the liquid in the temperature indicator has a semi-plastic consistency at temperatures below said limit value, but becomes liquid at temperatures above the same.
